(19) United States
(12) Patent Application Publication
(10) Pub. No.: US 2025/0221570 A1
(43) Pub. Date: Jul. 10, 2025

(54) COOKING CONTROL METHOD AND APPARATUS, DEVICE AND STORAGE MEDIUM

(71) Applicant: FOSHAN SHUNDE MIDEA ELECTRICAL HEATING APPLIANCES MANUFACTURING CO., LTD., Foshan (CN)

(72) Inventors: Yong LI, Foshan (CN); Jianhua ZHANG, Foshan (CN); Yidong HE, Foshan (CN); Shaocheng XU, Foshan (CN)

(21) Appl. No.: 18/918,927

(22) Filed: Oct. 17, 2024

(30) Foreign Application Priority Data
Jan. 5, 2024 (CN) 202410025227.5

(51) Int. Cl. A47J 36/32; A23L 5/10; A47J 27/04; F24C 15/32; H05B 1/02

(52) U.S. Cl. CPC A47J 36/321; A23L 5/13; A23L 5/17; A47J 27/04; F24C 15/322; H05B 1/0261; A47J 2027/043

(57) ABSTRACT

A cooking control method includes, in response to a cooking signal, controlling a heating apparatus of a cooking device to heat a cooking pot of the cooking device, to cause the cooking device to enter a first cooking stage, obtaining a steam temperature in the cooking pot, in response to the steam temperature being greater than or equal to a first temperature threshold and less than a second temperature threshold, controlling a circulation fan of the cooking device to operate, and, in response to the steam temperature being greater than or equal to the second temperature threshold, controlling the cooking device to enter a second cooking stage. A power of the heating apparatus in the second cooking stage is less than a power of the heating apparatus in the first cooking stage.

### CROSS-REFERENCE TO RELATED APPLICATION

This application claims priority Chinese Application No. 202410025227.5, filed Jan. 5, 2024, then entire content of which is incorporated herein by reference.

### TECHNICAL FIELD

The present disclosure relates to the technology field of control of electrical appliances, and in particular to a cooking control method and apparatus, a device and a storage medium.

### BACKGROUND

With the continuous development of cooking devices, people have higher requirements for cooking devices.

At present, when a cooking device is cooking, the liquid and food in the cooking device are heated unevenly, which would easily cause a part of the food to be half-cooked, thereby affecting the user's experience.

### SUMMARY

In view of the above, the present disclosure provides a cooking control method and apparatus, a device and a storage medium to alleviate the above problem.

In a first aspect, embodiments of the present disclosure provide a cooking control method for a cooking device. The cooking device includes a cooker body, a cooking pot, a heating apparatus and a circulation fan, and the cooking pot, the heating apparatus and the circulation fan are all located in the cooker body. The heating apparatus is located between the cooking pot and the cooker body, and the circulation fan is opposite to an opening of the cooking pot. The cooking control method includes: in response to a cooking signal, controlling the heating apparatus to heat the cooking pot, so as to make the cooking device enter a first cooking stage; obtaining a steam temperature in the cooking pot; in response to the steam temperature being greater than or equal to a first temperature threshold and less than a second temperature threshold, controlling the circulation fan to operate; and in response to the steam temperature being greater than or equal to the second temperature threshold, controlling the cooking device to enter a second cooking stage, where power of the heating apparatus in the second cooking stage is less than power of the heating apparatus in the first cooking stage.

In some embodiments, the cooking control method further includes: in response to the steam temperature being less than the first temperature threshold, controlling the circulation fan to operate in a first mode. The controlling the circulation fan to operate in response to the steam temperature being greater than or equal to the first temperature threshold and less than the second temperature threshold, includes: in response to the steam temperature being greater than or equal to the first temperature threshold and less than the second temperature threshold, controlling the circulation fan to operate in a second mode, where an average rotation speed of the circulation fan in the second mode is greater than the average rotation speed of the circulation fan in the first mode.

In some embodiments, the controlling the circulation fan to operate in the second mode includes: controlling the circulation fan to rotate periodically.

In some embodiments, the controlling the circulation fan to rotate periodically includes: controlling the circulation fan to rotate for a first time duration, and controlling the circulation fan to stop rotating for a second time duration, where the circulation fan alternates between the rotating and the stopping rotation.

In some embodiments, the cooking control method further includes: in response to the steam temperature being less than the first temperature threshold, controlling the circulation fan to stop operating.

In some embodiments, the cooking control method further includes: in response to the steam temperature being greater than or equal to the first temperature threshold and less than the second temperature threshold, obtaining a heating time that the heating apparatus has operated; and in response to the heating time being greater than or equal to a preset time, controlling the cooking device to enter the second cooking stage.

In some embodiments, the cooking control method further includes: in response to the heating time being less than the preset time, reobtaining the steam temperature in the cooking pot.

In a second aspect, the embodiments of the present disclosure provides a cooking control apparatus for a cooking device. The cooking device includes a cooker body, a cooking pot, a heating apparatus and a circulation fan, and the cooking pot, the heating apparatus and the circulation fan are all located in the cooker body. The heating apparatus is located between the cooking pot and the cooker body, and the circulation fan is opposite to an opening of the cooking pot. The cooking control apparatus includes: a first control module, an obtaining module, a second control module and a third control module. The first control module is configured to control, in response to a cooking signal, the heating apparatus to heat the cooking pot, so as to make the cooking device enter a first cooking stage. The obtaining module is configured to obtain a steam temperature in the cooking pot. The second control module is configured to control the circulation fan to operate, when the steam temperature is greater than or equal to a first temperature threshold and less than a second temperature threshold. The third control module is configured to control the cooking device to enter a second cooking stage, when the steam temperature is greater than or equal to the second temperature threshold, where power of the heating apparatus in the second cooking stage is less than power of the heating apparatus in the first cooking stage.

In a third aspect, the embodiments of the present disclosure provides a cooking device. The cooking device includes a cooker body, a cooking pot, a heating apparatus, a circulation fan, at least one processor and a memory, the cooking pot, the heating apparatus and the circulation fan are all located in the cooker body, and the memory communicates with the at least one processor. The heating apparatus is located between the cooking pot and the cooker body, and the circulation fan is opposite to an opening of the cooking pot. The memory stores instructions executable by the at least one processor, and the instructions, when being executed by the at least one processor, cause the at least one processor to execute the cooking control method of any of the embodiments mentioned above.

In a fourth aspect, the embodiments of the present disclosure further provides a computer-readable storage medium. The computer-readable storage medium stores therein program codes, and the program codes are invokable by a processor to execute the cooking control method of any of the embodiments mentioned above.

In the cooking control method and apparatus, the device and the storage medium provided in the present disclosure, the cooking control method is applied to a cooking device. The cooking device includes a cooker body, a cooking pot, a heating apparatus and a circulation fan, and the cooking pot, the heating apparatus and the circulation fan are all located in the cooker body. The heating apparatus is located between the cooking pot and the cooker body, and the circulation fan is opposite to an opening of the cooking pot. The cooking control method includes: in response to a cooking signal, controlling the heating apparatus to heat the cooking pot, so as to make the cooking device enter a first cooking stage; obtaining a steam temperature in the cooking pot; in response to the steam temperature being greater than or equal to a first temperature threshold and less than a second temperature threshold, controlling the circulation fan to operate; and in response to the steam temperature being greater than or equal to the second temperature threshold, controlling the cooking device to enter a second cooking stage, where power of the heating apparatus in the second cooking stage is less than power of the heating apparatus in the first cooking stage. As such, when the steam temperature is greater than or equal to the first temperature threshold and less than the second temperature threshold, the cooking device controls the circulation fan to rotate. In this case, when the steam temperature is close to the first temperature threshold, the rotation of the circulation fan can drive the air in the cooking pot to flow, so as to achieve an effect of removing stale odor from the food. In addition, the rotation of the circulation fan can also make the liquid and food (such as rice grains) in the cooking pot stirred, so that the food can roll in the liquid; and the circulation fan can further stir the mixture of rice and water by means of wind to speed up a heat exchange between an upper layer and a lower layer, so that the food is heated more evenly, thereby solving the problem that a part of the food would be half-cooked. When the steam temperature is close to the second temperature threshold, bubbles are easily generated in the cooking pot, and the rotation of the circulation fan can drive the air in the cooking pot to flow so as to destroy the bubbles.

### BRIEF DESCRIPTION OF THE DRAWINGS

In order to explain the technical schemes in the embodiments of the present disclosure more clearly, the drawings needed in the description of the embodiments are briefly introduced below. Obviously, the drawings in the following description illustrate only some embodiments of the present disclosure, but not all of them. All other embodiments and drawings, obtained by those skilled in the art based on the embodiments of the present disclosure without creative work, fall within the scope of protection of the present disclosure.

FIG. 1 illustrates a schematic a structural diagram of a cooking device provided in the embodiments of the present disclosure.

FIG. 2 illustrates another schematic structural diagram of the cooking device of FIG. 1.

FIG. 3 illustrates a flowchart of a cooking control method provided in the embodiments of the present disclosure.

FIG. 4 illustrates a schematic structural diagram of of a cooking control apparatus provided in the embodiments of the present disclosure.

FIG. 5 illustrates a schematic structural diagram of a cooking device provided in another embodiment of the present disclosure.

FIG. 6 illustrates a structural block diagram of a computer-readable storage medium provided in the embodiments of the present disclosure.

### DETAILED DESCRIPTION OF EMBODIMENTS

In order to make the skilled in the art better understand the schemes of the present disclosure, technical schemes of the embodiments of the present disclosure are described clearly in detail below with reference to the accompanying drawings.

A cooking control method and apparatus, a device and a storage medium are provided in the embodiments of the present disclosure. The cooking control method is applied to a cooking device, and the cooking device includes a cooker body, a cooking pot, a heating apparatus and a circulation fan, and the cooking pot, the heating apparatus and the circulation fan are all located in the cooker body. The heating apparatus is located between the cooking pot and the cooker body, and the circulation fan is opposite to an opening of the cooking pot. The cooking control method includes: in response to a cooking signal, controlling the heating apparatus to heat the cooking pot, so as to make the cooking device enter a first cooking stage; obtaining a steam temperature in the cooking pot; in response to the steam temperature being greater than or equal to a first temperature threshold and less than a second temperature threshold, controlling the circulation fan to operate; and in response to the steam temperature being greater than or equal to the second temperature threshold, controlling the cooking device to enter a second cooking stage, where power of the heating apparatus in the second cooking stage is less than power of the heating apparatus in the first cooking stage. As such, when the steam temperature is greater than or equal to the first temperature threshold and less than the second temperature threshold, the cooking device controls the circulation fan to rotate. In this case, when the steam temperature is close to the first temperature threshold, the rotation of the circulation fan can drive the air in the cooking pot to flow, so as to achieve an effect of removing stale odor from the food. In addition, the rotation of the circulation fan can also make the liquid and food (such as rice grains) in the cooking pot stirred, so that the food can roll in the liquid; and the circulation fan can further stir the mixture of rice and water by means of wind to speed up a heat exchange between an upper layer and a lower layer, so that the food is heated more evenly, thereby solving the problem that a part of the food would be half-cooked. When the steam temperature is close to the second temperature threshold, bubbles are easily generated in the cooking pot, and the rotation of the circulation fan can drive the air in the cooking pot to flow so as to destroy the bubbles.

Technical schemes of the embodiments of the present disclosure are described clearly and comprehensively below with reference to the accompanying drawings.

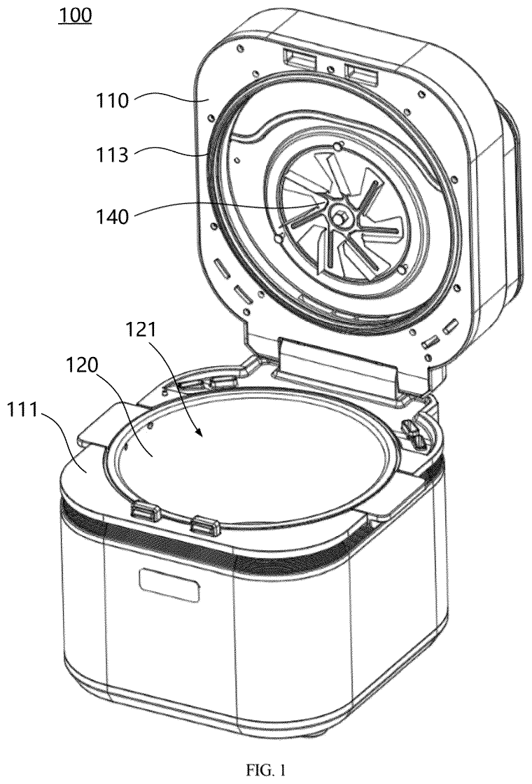

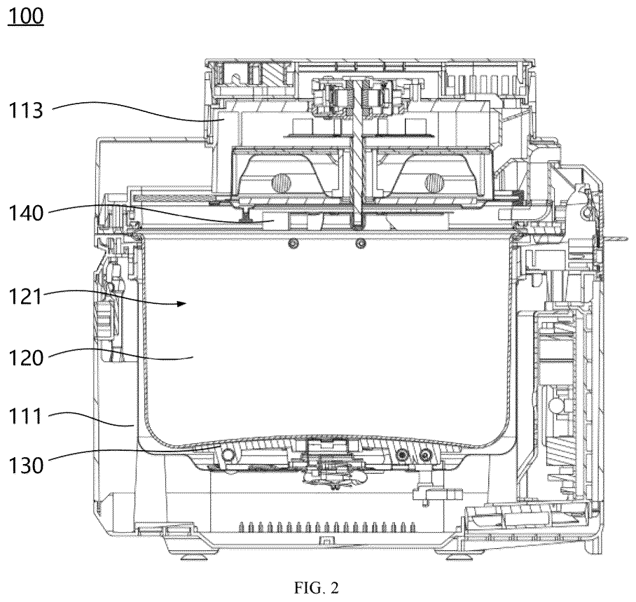

Referring to FIG. 1 to FIG. 2, the embodiments of the present disclosure provides a cooking device 100, and the cooking device 100 includes a cooker body 110, a cooking pot 120, a heating apparatus 130 and a circulation fan 140. Each of the cooking pot 120, the heating apparatus 130 and the circulation fan 140 is located in the cooker body 110. The heating apparatus 130 is located between the cooker body 110 and the cooking pot 120, to heat the cooking pot 120. The circulation fan 140 is opposite to an opening of the cooking pot 120, so that the circulation fan 140, when operating, can blow air into the cooking pot 120 and drive the air in the cooking pot 120 to flow, so as to destroy bubbles. This is conductive to preventing generation of the bubbles.

The cooking device 100 may be an air fryer, an oven, a rice cooker, a stewing cooker, an electric pressure cooker, a steam rice cooker, etc., which is not limited in the present disclosure.

In some embodiments, the cooker body 110 may include a main body 111 and a pot cover 113. The pot cover 113 may cover the main body 111, and each of the cooking pot 120, the heating apparatus 130 and the circulation fan 140 is located between the pot cover 113 and the main body 111.

In some embodiments, the main body 111 and the pot cover 113 may be connected in multiple ways. For example, the pot cover 113 may be hinged to the main body 111, or the pot cover 113 and the main body 111 may be separate structures, or the main body 111 and the pot cover 113 may also be connected in other ways.

In some embodiments, a heating space may be provided in the main body 111, and both the heating apparatus 130 and the cooking pot 120 are located in the heating space.

In some embodiments, the heating apparatus 130 may be located between a bottom wall of the cooking pot 120 and a bottom wall of the cooker body 110, so that the food in the cooking pot 120 is more easily heated.

In some other embodiments, the heating apparatus 130 may also be located between a side wall of the cooking pot 120 and a side wall of the cooker body 110.

In some other embodiments, there may be multiple heating apparatuses 130, and the multiple heating apparatuses 130 may be distributed between the bottom wall of the cooking pot 120 and the bottom wall of the cooker body 110, and between the side wall of the cooking pot 120 and the side wall of the cooker body 110, so that the heating efficiency can be improved and a cooking speed of the cooking device 100 can be improved.

In some embodiments, the heating apparatus 130 may be a heating tube, a heating plate, an electromagnetic heating element or other heating elements or apparatuses.

In some embodiments, the circulation fan 140 may be connected to the pot cover 113. It is understandable that, when the pot cover 113 covers the main body 111, the circulation fan 140 may be located in the cooking pot 120, or the circulation fan 140 may be located outside the cooking pot 120 and opposite to the opening of the cooking pot 120, or the circulation fan 140 may be partially located in the cooking pot 120.

In some embodiments, an inner wall of the cooking pot 120 may be provided with an indicator indicating a liquid volume to a user, such as a water line.

In some embodiments, the cooking device 100 may further include a motor. The motor may be installed in the pot cover 113. A driving shaft of the motor may extend out of the pot cover 113, and the circulation fan 140 may be connected to the driving shaft, so that the motor may control the circulation fan 140 to rotate.

In some embodiments, a cooking space 121 may be provided in the cooking pot 120, and food may be placed in the cooking space 121.

It is understandable that, when the pot cover 113 covers the main body 111, the cooking space 121 may refer to a space between the cooking pot 120 and the pot cover 113. When the pot cover 113 covers the main body 111, the cooking space 121 may be sealed, which is conductive to alleviating a problem of steam loss when the cooking device 100 cooks.

In some embodiments, the cooking device 100 may further include a temperature detection unit, and the temperature detection unit may be disposed in the cooking space 121. For example, the temperature detection unit may be disposed at the pot cover 113, so that the temperature detection unit may obtain the steam temperature in the cooking pot 120.

The temperature detection unit may be a temperature sensor, a thermometer and other temperature detection components.

In some embodiments, the cooker body 110 may be provided thereon with an exhaust hole, and the exhaust hole may exhaust the steam in the cooking space 121 to relieve the pressure therein. The temperature detection unit may be located in the exhaust hole, so that the temperature detection unit may obtain the steam temperature in the cooking pot 120.

In some embodiments, the cooking device 100 may further include a controller, and the controller may be located in the cooker body 110. The controller may be configured to control operating states of the circulation fan 140 and the heating apparatus 130. The controller may further obtain a detection value of the temperature detection unit, and control, according to the detection value, the operating states of the circulation fan 140 and the heating apparatus 130 and so on. The controller may be configured to perform any step in the cooking control method of any of the implementations mentioned below.

The controller may be a MCU (Microcontroller Unit), an MPU (Microprocessor Unit), a CPU (Central Processing Unit), etc.

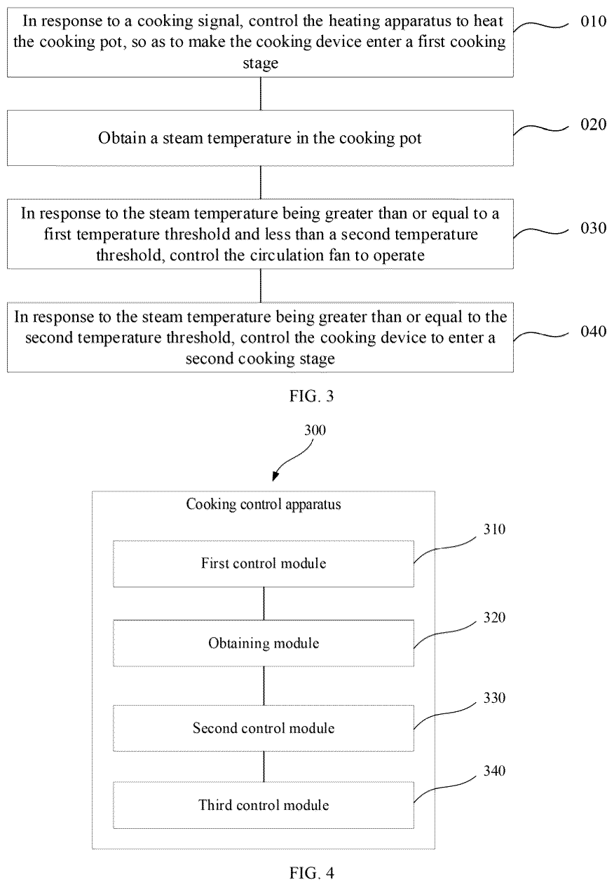

Referring to FIG. 3, the embodiments of the present disclosure further provides a cooking control method. The cooking control method is applied to the cooking device 100 of any of the implementations mentioned above. The cooking control method includes steps 010, 020, 030 and 040.

In step 010, in response to a cooking signal, the heating apparatus is controlled to heat the cooking pot, so as to make the cooking device enter a first cooking stage.

In some embodiments, the cooking signal may be triggered by the user, and the controller may obtain the cooking signal by obtaining an input operation of the user through interaction with the user. For example, the cooking device may be provided with an interactive panel, and the user may click a button(s) or selection control(s), that is (are) related to sending of a cooking signal, on the interactive panel (such as a key panel or a touch screen). Alternatively, the user may trigger the cooking signal by sending a preset specific voice, through infrared control, by sending a specific instruction with a mobile terminal, and the like.

In some embodiments, upon receiving the cooking signal, the cooking device enters a cooking mode.

In some embodiments, after the cooking is finished, the cooking device may further send, to the user, a prompt that the cooking has finished. For example, after the cooking is finished, the cooking device makes a prompt sound, a piece of voice broadcast, flashing light and so on.

In some embodiments, the heating apparatus may heat the cooking pot by electromagnetic heating or through a heating plate or a heating pipe, or other ways, which is not limited in the present disclosure.

In step 020, the steam temperature in the cooking pot is obtained.

The steam temperature in the cooking pot may refers to a steam temperature directly detected by the temperature detection unit in the cooking pot when the temperature detection unit is located in the cooking pot, or a steam temperature detected by the temperature detection unit in the exhaust hole when the temperature detection unit is located in the exhaust hole and the steam in the cooking pot flows through the exhaust hole.

It is understandable that the steam temperature is generally lower than the temperature of the liquid in the cooking pot. In the embodiments of the present disclosure, by obtaining the steam temperature, it may be ensured that the temperature of the liquid in the cooking pot is higher than the detected steam temperature, thereby improving a fault tolerance rate of the cooking control method.

In step 030, in response to the steam temperature being greater than or equal to a first temperature threshold and less than a second temperature threshold, the circulation fan is controlled to operate.

In the embodiments of the present disclosure, after the heating apparatus heats the cooking pot, the cooking device enters the first cooking stage, and it obtains the steam temperature, and makes determination based on the steam temperature. When the steam temperature is greater than or equal to the first temperature threshold and less than the second temperature threshold, the circulation fan is controlled to operate. In this case, when the steam temperature is close to the first temperature threshold, the rotation of the circulation fan can drive the air in the cooking pot to flow, so as to achieve an effect of removing stale odour from the food. In addition, the rotation of the circulation fan can also make the liquid and food (such as rice grains) in the cooking pot stirred, so that the food can roll in the liquid; and the circulation fan can further stir the mixture of rice and water by means of wind to speed up a heat exchange between an upper layer and a lower layer, so that the food is heated more evenly, thereby solving the problem that a part of the food is half-cooked. When the steam temperature is close to the second temperature threshold, bubbles are easily generated in the cooking pot, and the rotation of the circulation fan rotates can drive the air in the cooking pot to flow so as to destroy the bubbles.

In some embodiments, the second temperature threshold is greater than the first temperature threshold.

In some embodiments, when the steam temperature is greater than or equal to the first temperature threshold and less than the second temperature threshold, the cooking device is determined to be in the first cooking stage; and in this case, the operating power of the heating apparatus is large, and it is easy to generate bubbles. The rotation of the circulation fan in the first cooking stage drives the air in the cooking pot to flow, so as to avoid generation of the bubbles.

In some embodiments, the first temperature threshold and the second temperature threshold may be preset according to actual situations. The first temperature threshold may be 35° C., and the second temperature threshold may be 80° C. When the steam temperature is greater than or equal to 35° C. and less than 80° C., for example, when the steam temperature is 35° C., 50° C., 68° C., 71° C. or 79° C., the cooking device controls the circulation fan to start rotating.

In addition, the cooking device may also adjust the operating mode of the circulation fan according to the steam temperature.

Specifically, in some embodiments, the cooking control method further includes a step of:
in response to the steam temperature being less than the first temperature threshold, controlling the circulation fan to operate in a first mode.

In addition, step 030 may include: in response to the steam temperature being greater than or equal to the first temperature threshold and less than the second temperature threshold, controlling the circulation fan to operate in a second mode.

An average rotation speed of the circulation fan in the second mode is greater than an average rotation speed of the circulation fan in the first mode.

In some embodiments, the difference between the first mode and the second mode may lie in the rotation speed or the operating power. For example, the operating power of the circulation fan in the second mode is greater than the operating power of the circulation fan in the first mode.

After obtaining the cooking signal, the cooking device controls the heating apparatus to start heating the cooking pot, and controls the circulation fan to start rotating. Before the cooking device enters the first cooking stage, it is difficult for the liquid in the cooking pot to generate bubbles; and at this time, in order to reduce the power consumption of the circulation fan, the cooking device may reduce the rotation speed of the circulation fan and thus reduce an energy consumption of the cooking device, and then the circulation fan operates in the first mode in which the rotation speed of the circulation fan is a first rotation speed. After the cooking device enters the first cooking stage, in order to provide more wind power, the cooking device may increase the rotation speed of the circulation fan, and the circulation fan provides more wind power, which can achieve a better effect of removing the stale odour, and can quickly destroy the surface tension of bubbles. This is helpful to prevent the liquid from generating bubbles or destroying the generated bubbles. At this time, the circulation fan operates in the second mode in which the rotation speed of the circulation fan is a second rotation speed greater than the first rotation speed.

In some embodiments, the first rotation speed and the second rotation speed may be preset as required. Optionally, the first rotation speed may be less than 2000 rpm, for example, the first rotation speed may be set as 1900 rpm, 1800 rpm or 1650 rpm, and so on. The second rotation speed may be greater than or equal to 2000 rpm, and less than or equal to 5000 rpm, for example, the second rotation speed may be set as 2000 rpm, 3500 rpm or 5000 rpm, etc.

It is understandable that, before the cooking device enters the first cooking stage, the energy consumption of the cooking device may be further reduced.

Specifically, in some embodiments, the cooking control method further includes a step of:
in response to the steam temperature being less than the first temperature threshold, controlling the circulation fan to stop operating.

Before the cooking device enters the first cooking stage, that is, when the steam temperature is less than the first temperature threshold, it is difficult for the liquid in the cooking pot to generate bubbles; at this time, the circulation fan may stop operating to reduce the energy consumption of the cooking device. In addition, when the circulation fan stops operating, a heat loss may be reduced, so that the cooking device may enter the first cooking stage more quickly, and the cooking speed of the cooking device is improved.

In the cooking control method provided in the embodiments of the present disclosure, when the steam temperature is less than the first temperature threshold, the cooking device determines that the first cooking stage has not been entered at that time and it is difficult to generate bubbles in the cooking pot. In order to reduce the energy consumption, the circulation fan may or may not operate. Further, if the circulation fan operates, the circulation fan operates in the first mode with low power consumption, so as to stir the air or liquid in the cooking pot, which enables the food to be heated more evenly; this is not only helpful to remove stale odour from the food, but also alleviate the problem that a part of the food would be half-cooked.

In addition, the cooking device may further adjust an operating period of the circulation fan in the first cooking stage.

Specifically, in some embodiments, the controlling the circulation fan to operate in the second mode in the above step 030 may include: controlling the circulation fan to rotate periodically. That is, step 030 may include: in response to the steam temperature being greater than or equal to the first temperature threshold and less than the second temperature threshold, controlling the circulation fan to rotate periodically.

When the cooking device is in the first cooking stage, it takes a certain time to generate bubbles in the cooking pot. Therefore, the cooking device may control the circulation fan to operate periodically, which may not only reduce the generation of bubbles, but also reduce the energy consumption of the cooking device.

In some embodiments, the circulation fan rotating periodically may refer to that the circulation fan operates at a preset interval.

As an example, the interval may be 10 seconds, and the circulation fan starts every 10 seconds.

As another example, the interval may be 20 seconds, and the circulation fan starts every 20 seconds.

In some embodiments, the controlling the circulation fan to rotate periodically in step 030 may include: controlling the circulation fan to rotate for a first time duration, and controlling the circulation fan to stop rotating for a second time duration, where the circulation fan alternates between such rotating and stopping rotation. That is, step 030 may include: in response to the steam temperature being greater than or equal to the first temperature threshold and less than the second temperature threshold, controlling the circulation fan to rotate for the first time duration, and controlling the circulation fan to stop rotating for the second time duration, where the circulation fan alternates between the rotating and stopping rotation.

In some embodiments, the first time duration and the second time duration may be preset.

In some embodiments, the first time duration and the second time duration may be equal or may not be equal. The first time duration may be greater than the second time duration, and the first time duration may also be less than the second time duration.

As an example, the first time duration may be 10 seconds, the second time duration may be 10 seconds, and the circulation fan alternates between rotating for 10 seconds and stopping rotation for 10 seconds.

As another example, the first time duration may be 10 seconds, the second time duration may be 20 seconds, and the circulation fan alternates between rotating for 10 seconds and stopping rotation for 20 seconds.

In step 040, in response to the steam temperature being greater than or equal to the second temperature threshold, the cooking device is controlled to enter a second cooking stage.

The power of the heating apparatus in the second cooking stage is less than the power of the heating apparatus in the first cooking stage.

When the steam temperature is greater than or equal to the second temperature threshold, the first cooking stage is finished, and the cooking device enters the second cooking stage. It is understandable that, at this time, the circulation fan may stop operating or may also operate in an operating mode of the second cooking stage.

In some embodiments, the cooking device may have multiple cooking stages during cooking. Taking cooking meals as an example, the cooking device may have a detection stage, a heating-up stage, a boiling stage, a stewing stage and so on, in this order. In the detection stage, the cooking device may detect whether the water level in the cooking pot exceeds the water line, or whether the pot cover tightly covers the main body, or whether the exhaust hole is blocked, etc. The first cooking stage may refer to the heating stage, and the second cooking stage may refer to the boiling stage.

In some embodiments, the heating power of the heating apparatus in the multiple cooking stages may be different. For example, the heating power of the heating apparatus in the heating stage may be greater than the heating power of the heating apparatus in other cooking stages.

It is understandable that, in the heating-up stage, in order to make the food enter the boiling stage faster, the heating apparatus operates in a full power or close to the full-power state, and the heating power of the heating apparatus is high. When the steam temperature is close to the second temperature threshold, it is easy to generate bubbles in the cooking pot. The cooking device may control the circulation fan to operate, so as to stir the air in the cooking pot, and reduce the generation of bubbles or destroy the generated bubbles.

In the cooking control method provided in the embodiments of the present disclosure, the cooking control method is applied to the cooking device including the cooker body, the cooking pot, the heating apparatus and the circulation fan, where the cooking pot, the heating apparatus and the circulation fan are all located in the cooker body. The heating apparatus is located between the cooking pot and the cooker body, and the circulation fan is opposite to the opening of the cooking pot. The cooking control method includes: in response to the cooking signal, controlling the heating apparatus to heat the cooking pot, so as to make the cooking device enter the first cooking stage; obtaining the steam temperature in the cooking pot; in response to the steam temperature being greater than or equal to the first temperature threshold and less than the second temperature threshold, controlling the circulation fan to operate; in response to the steam temperature being greater than or equal to the second temperature threshold, controlling the cooking device to enter the second cooking stage, where the power of the heating apparatus in the second cooking stage is less than the power of the heating apparatus in the first cooking stage. As such, when the steam temperature is greater than or equal to the first temperature threshold and less than the second temperature threshold, the cooking device controls the circulation fan to rotate. In this case, when the steam temperature is close to the first temperature threshold, the rotation of the circulation fan can drive the air in the cooking pot to flow, so as to achieve the effect of removing stale odour from the food. In addition, the rotation of the circulation fan can also make the liquid and food (such as rice grains) in the cooking pot stirred, so that the food can roll in the liquid, which enables the food to be heated more evenly, and alleviates the problem that a part of the food is half-cooked. When the steam temperature is close to the second temperature threshold, it is easy to generate bubbles in the cooking pot, and the rotation of the circulation fan can drive the air in the cooking pot to flow so as to destroy the bubbles.

In some embodiments, the cooking control method may further include following steps.
(1) In response to the steam temperature being greater than or equal to the first temperature threshold and less than the second temperature threshold, a heating time that the heating apparatus has operated is obtained.
(2) In response to the heating time being greater than or equal to a preset time, the cooking device is controlled to enter the second cooking stage.

When the cooking device cooks, the current operating stage of the cooking device may be determined accurately by monitoring the steam temperature and the heating time at the same time, so as to control the operating state of the circulation fan accurately.

Specifically, during cooking of the cooking device, when the steam temperature is greater than or equal to the first temperature threshold and less than the second temperature threshold, due to a certain difference between the steam temperature and the actual temperature of the liquid in the cooking pot, or due to aging or damage of the temperature detection unit, the detected steam temperature would be not accurate and thus the circulation fan would be controlled incorrectly. In this case, the cooking device may determine the current cooking stage thereof according to the heating time that the heating apparatus has operated. When the heating time reaches the preset time, the cooking device determines that the first cooking stage has been finished and the cooking device is currently in the second cooking stage, and then controls the circulation fan to stop operating or operate in the operating mode of the second cooking stage.

In some embodiments, the heating time may be preset as required. Optionally, the heating time may be greater than or equal to 30 min, and less than or equal to 50 min. For example, the heating time may be 30 min, 35 min, 43 min or 50 min, etc.

In some embodiments, the cooking control method may further include a step of:
in response to the heating time being less than the preset time, reobtaining the steam temperature in the cooking pot.

When the heating time is less than the preset time, the cooking device determines that it shall still be in the first cooking stage and bubbles would still probably appear in the cooking pot. In this case, the cooking device reobtains the steam temperature, and the circulation fan still operates, which is helpful to destroy the bubbles in the cooking pot.

Referring to FIG. 4, the embodiments of the present disclosure further provides a cooking control apparatus 300, and the cooking control apparatus 300 is applied to a cooking device. The cooking device includes a cooker body, a cooking pot, a heating apparatus and a circulation fan, and the cooking pot, the heating apparatus and the circulation fan are all located in the cooker body. The heating apparatus is located between the cooking pot and the cooker body, and the circulation fan is opposite to an opening of the cooking pot. The cooking control apparatus 300 may be configured to perform any step of the cooking control method of any of the implementations mentioned above. For example, the cooking control apparatus 300 includes a first control module 310, an obtaining module 320, a second control module 330 and a third control module 340.

The first control module 310 is configured to control, in response to a cooking signal, the heating apparatus to heat the cooking pot, so as to make the cooking device enter a first cooking stage.

The obtaining module 320 is configured to obtain a steam temperature in the cooking pot.

The second control module 330 is configured to control the circulation fan to operate, when the steam temperature is greater than or equal to a first temperature threshold and less than a second temperature threshold.

The third control module 340 is configured to control the cooking device to enter a second cooking stage when the steam temperature is greater than or equal to the second temperature threshold, where power of the heating apparatus in the second cooking stage is less than power of the heating apparatus in the first cooking stage.

In some embodiments, the second control module 330 is further configured to: control the circulation fan to operate in a first mode, when the steam temperature is less than the first temperature threshold; and control the circulation fan to operate in a second mode, when the steam temperature is greater than or equal to the first temperature threshold and less than the second temperature threshold.

In some embodiments, the second control module 330 is further configured to control the circulation fan to rotate periodically, when the steam temperature is greater than or equal to the first temperature threshold and less than the second temperature threshold.

In some embodiments, the second control module 330 is further configured to, when the steam temperature is greater than or equal to the first temperature threshold and less than the second temperature threshold, control the circulation fan to rotate for a first time duration, and control the circulation fan to stop rotating for a second time duration, in such a manner that the circulation fan alternates between the rotating and the stopping rotation.

In some embodiments, the second control module 330 is further configured to control the circulation fan to stop operating, when the steam temperature is less than the first temperature threshold.

In some embodiments, the second control module 330 is further configured to obtain a heating time that the heating apparatus has operated, when the steam temperature is greater than or equal to the first temperature threshold and less than the second temperature threshold. The third control module 340 is further configured to control the cooking device to enter the second cooking stage, when the heating time is greater than or equal to a preset time.

In some embodiments, the obtaining module 320 is further configured to reobtain the steam temperature in the cooking pot, when the heating time is less than the preset time.

It is notable that, for the apparatus embodiments, because they are substantially similar to the method embodiments, the description thereof is relatively simple, and the relevant contents may refer to the description of the method embodiments. Any processing described in the method embodiments may be realized by a corresponding processing module in the apparatus embodiments, which are described in detail in the apparatus embodiments.

It may be clearly understandable for those skilled in the art that, for the convenience and conciseness of description, the specific operating processes of the apparatus and modules described above may refer to the corresponding processes in the aforementioned method embodiments, which are not repeated here.

In several embodiments of the present disclosure, the coupling between the modules may be electrical, mechanical or in other forms.

In addition, the various functional modules in the embodiments of the present disclosure may be integrated into one processing module, or each module may exist physically alone, or two or more modules may be integrated into one module. The integrated modules may be implemented in the form of hardware or software functional modules.

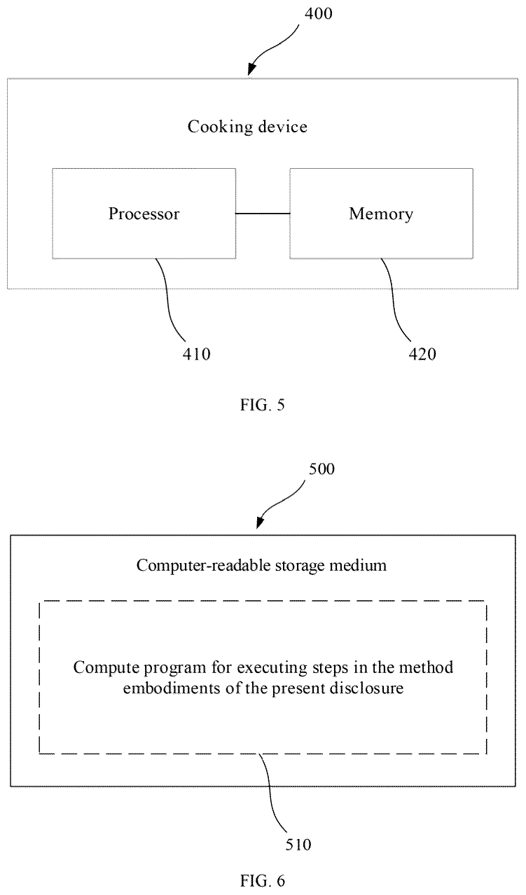

Referring to FIG. 5, based on the above cooking control method, the embodiments of the present disclosure further provides a cooking device 400 that may execute the above cooking control method.

The cooking device 400 includes a cooker body, a cooking pot, a heating apparatus and a circulation fan, and the cooking pot, the heating apparatus and the circulation fan are all located in the cooker body. The heating apparatus is located between the cooking pot and the cooker body, and the circulation fan is opposite to an opening of the cooking pot.

The cooking device 400 further includes at least one processor 410 and a memory 420. Furthermore, the cooking device may further include a touch panel (which is not illustrated in the drawings), a touch screen (which is not illustrated in the drawings) and a wireless communication module (which is not illustrated in the drawings), and one or more application programs, where the one or more application programs may be stored in the memory 420 and configured to be executed by one or more processors 410. The one or more programs are configured to perform the method described in the aforementioned method embodiments.

The processor 410 may include one or more processing cores. The processor 410 connects various parts in the whole cooking device 400 with various interfaces and lines, and executes various functions and processes data of the cooking device 400 by running or executing instructions, programs, code sets or instruction sets stored in the memory 420 and calling data stored in the memory 420.

Optionally, the processor 410 may be implemented in at least one of a digital signal processing (DSP), a field-programmable gate array (FPGA), or a programmable logic array (PLA). The processor 410 may be integrated with one of a central processing unit (CPU), a graphics processing unit (GPU) and a modem, or a combination thereof. CPU mainly processes an operating system, a user interface and application programs. GPU is configured to render and draw displayed content. The modem is configured to process wireless communication. It may be understandable that the modem may also be implemented as one separate communication chip without being integrated into the processor 410.

The memory 420 may include a random access memory (RAM) or a read-only memory. The memory 420 may be configured to store instructions, programs, codes, code sets or instruction sets. The memory 420 may include a program storage area and a data storage area. The program storage area may store instructions for realizing an operating system, instructions for realizing at least one function, instructions for realizing multiple method embodiments described above, and the like. The data storage area may further store data created by a terminal in use.

Referring to FIG. 6, the embodiments of the present disclosure further provides a computer-readable storage medium 500. The computer-readable storage medium 500 stores program codes 510 which may be invoked by a processor to execute the cooking control method described in the above method embodiments.

The computer-readable storage medium 500 may be an electronic memory, such as flash memory, EEPROM (Electrically Erasable Programmable Read Only Memory), EPROM, hard disk or ROM. Optionally, the computer-readable storage medium 500 includes a non-transitory computer-readable storage medium. The computer-readable storage medium 500 has a storage space for program codes 510 for executing any method step in the above method. These program codes may be read from or written into one or more computer program products. The program codes 510 may be compressed in an appropriate form.

Finally, it is notable that the above embodiments are only used to illustrate the technical schemes of the present disclosure, rather than limiting them. Under the concept of the present disclosure, technical features in the above embodiments or different embodiments may further be combined, the steps may be realized in any order, and there are many other changes in different aspects of the present disclosure, which are not provided in detail for brevity. Although the present disclosure has been described in detail with reference to the foregoing embodiments, it shall be understandable for those skilled in the art that they may still modify the technical schemes described in the foregoing embodiments or make an equivalent substitution on some of the technical features. However, these modifications or substitutions do not make the essence of the corresponding technical schemes depart from the scope of the technical schemes of various embodiments of the present disclosure. Through the description of the above embodiments, it may be clearly understandable for those skilled in the art that each of the embodiments may be realized by means of software and a general hardware platform, and of course, it may further be realized by hardware. It may be understandable for those skilled in the art that, all or a part of the processes in the above method embodiments may be implemented by means of a program that instructs related hardware through program codes and may be stored in a computer-readable storage medium; when the program is executed, the processes of the methods mentioned above may be enabled. The storage medium may be a magnetic disk, an optical disk, a read-only memory (ROM) or a random access memory (RAM).

1. A cooking control method comprising:
in response to a cooking signal, controlling a heating apparatus of a cooking device to heat a cooking pot of the cooking device, to cause the cooking device to enter a first cooking stage, the cooking device further including a cooker body and a circulation fan, the cooking pot, the heating apparatus, and the circulation fan being located in the cooker body, the heating apparatus being located between the cooking pot and the cooker body, and the circulation fan being opposite to an opening of the cooking pot;
obtaining a steam temperature in the cooking pot;
in response to the steam temperature being greater than or equal to a first temperature threshold and less than a second temperature threshold, controlling the circulation fan to operate; and
in response to the steam temperature being greater than or equal to the second temperature threshold, controlling the cooking device to enter a second cooking stage, a power of the heating apparatus in the second cooking stage being less than a power of the heating apparatus in the first cooking stage.

2. The cooking control method of claim 1, further comprising:
in response to the steam temperature being less than the first temperature threshold, controlling the circulation fan to operate in a first mode;
wherein:
controlling the circulation fan to operate in response to the steam temperature being greater than or equal to the first temperature threshold and less than the second temperature threshold includes, in response to the steam temperature being greater than or equal to the first temperature threshold and less than the second temperature threshold, controlling the circulation fan to operate in a second mode; and
an average rotation speed of the circulation fan in the second mode is greater than an average rotation speed of the circulation fan in the first mode.

3. The cooking control method of claim 2, wherein controlling the circulation fan to operate in the second mode includes:
controlling the circulation fan to rotate periodically.

4. The cooking control method of claim 3, wherein controlling the circulation fan to rotate periodically includes:
controlling the circulation fan to alternate between rotating for a first time duration and stopping rotating for a second time duration.

5. The cooking control method of claim 1, further comprising:
in response to the steam temperature being less than the first temperature threshold, controlling the circulation fan to stop operating.

6. The cooking control method of claim 1, further comprising:
in response to the steam temperature being greater than or equal to the first temperature threshold and less than the second temperature threshold, obtaining a heating time that the heating apparatus has operated; and
in response to the heating time being greater than or equal to a preset time, controlling the cooking device to enter the second cooking stage.

7. The cooking control method of claim 6, further comprising:
in response to the heating time being less than the preset time, reobtaining the steam temperature in the cooking pot.

8. A cooking device comprising:
a cooker body;
a cooking pot, a heating apparatus, and a circulation fan located in the cooker body, the heating apparatus being located between the cooking pot and the cooker body, and the circulation fan being opposite to an opening of the cooking pot;
at least one processor; and
a memory communicating with the at least one processor and storing instructions that, when executed by the at least one processor, cause the at least one processor to:
in response to a cooking signal, control the heating apparatus to heat the cooking pot, to cause the cooking device to enter a first cooking stage;
obtain a steam temperature in the cooking pot;
in response to the steam temperature being greater than or equal to a first temperature threshold and less than a second temperature threshold, control the circulation fan to operate; and
in response to the steam temperature being greater than or equal to the second temperature threshold, control the cooking device to enter a second cooking stage, a power of the heating apparatus in the second cooking stage being less than a power of the heating apparatus in the first cooking stage.

9. The cooking device of claim 8, wherein the instructions, when executed by the at least one processor, further cause the at least one processor to:
in response to the steam temperature being less than the first temperature threshold, control the circulation fan to operate in a first mode; and
in response to the steam temperature being greater than or equal to the first temperature threshold and less than the second temperature threshold, control the circulation fan to operate in a second mode, an average rotation speed of the circulation fan in the second mode being greater than an average rotation speed of the circulation fan in the first mode.

10. The cooking device of claim 9, wherein the instructions, when executed by the at least one processor, further cause the at least one processor to, when controlling the circulation fan to operate in the second mode:
control the circulation fan to rotate periodically.

11. The cooking device of claim 10, wherein the instructions, when executed by the at least one processor, further cause the at least one processor to, when controlling the circulation fan to rotate periodically:
control the circulation fan to alternate between rotating for a first time duration and stopping rotating for a second time duration.

12. The cooking device of claim 8, wherein the instructions, when executed by the at least one processor, further cause the at least one processor to:
in response to the steam temperature being less than the first temperature threshold, control the circulation fan to stop operating.

13. The cooking device of claim 8, wherein the instructions, when executed by the at least one processor, further cause the at least one processor to:
in response to the steam temperature being greater than or equal to the first temperature threshold and less than the second temperature threshold, obtain a heating time that the heating apparatus has operated; and
in response to the heating time being greater than or equal to a preset time, control the cooking device to enter the second cooking stage.

14. The cooking device of claim 13, wherein the instructions, when executed by the at least one processor, further cause the at least one processor to:
in response to the heating time being less than the preset time, reobtain the steam temperature in the cooking pot.

15. A non-transitory computer-readable storage medium storing one or more program codes that, when executed by at least one processor, cause the at least one processor to:
in response to a cooking signal, control a heating apparatus of a cooking device to heat a cooking pot of the cooking device, to cause the cooking device to enter a first cooking stage, the cooking device further including a cooker body and a circulation fan, the cooking pot, the heating apparatus, and the circulation fan being located in the cooker body, the heating apparatus being located between the cooking pot and the cooker body, and the circulation fan being opposite to an opening of the cooking pot;
obtain a steam temperature in the cooking pot;
in response to the steam temperature being greater than or equal to a first temperature threshold and less than a second temperature threshold, control the circulation fan to operate; and
in response to the steam temperature being greater than or equal to the second temperature threshold, control the cooking device to enter a second cooking stage, a power of the heating apparatus in the second cooking stage being less than a power of the heating apparatus in the first cooking stage.

16. The storage medium of claim 15, wherein the one or more program codes, when executed by the at least one processor, further cause the at least one processor to:
in response to the steam temperature being less than the first temperature threshold, control the circulation fan to operate in a first mode; and
in response to the steam temperature being greater than or equal to the first temperature threshold and less than the second temperature threshold, control the circulation fan to operate in a second mode, an average rotation speed of the circulation fan in the second mode being greater than an average rotation speed of the circulation fan in the first mode.

17. The storage medium of claim 16, wherein the one or more program codes, when executed by the at least one processor, further cause the at least one processor to, when controlling the circulation fan to operate in the second mode:
control the circulation fan to rotate periodically.

18. The storage medium of claim 17, wherein the one or more program codes, when executed by the at least one processor, further cause the at least one processor to, when controlling the circulation fan to rotate periodically:
control the circulation fan to alternate between rotating for a first time duration and stopping rotating for a second time duration.

19. The storage medium of claim 15, wherein the one or more program codes, when executed by the at least one processor, further cause the at least one processor to:
in response to the steam temperature being less than the first temperature threshold, control the circulation fan to stop operating.

20. The storage medium of claim 15, wherein the one or more program codes, when executed by the at least one processor, further cause the at least one processor to:
in response to the steam temperature being greater than or equal to the first temperature threshold and less than the second temperature threshold, obtain a heating time that the heating apparatus has operated; and
in response to the heating time being greater than or equal to a preset time, control the cooking device to enter the second cooking stage.
